(19) United States
(12) Patent Application Publication
(10) Pub. No.: US 2023/0262236 A1
(43) Pub. Date: Aug. 17, 2023

(54) ANALYSIS DEVICE, ANALYSIS METHOD, AND COMPUTER-READABLE RECORDING MEDIUM STORING ANALYSIS PROGRAM

(71) Applicant: FUJITSU LIMITED, Kawasaki-shi (JP)

(72) Inventors: Tomonori KUBOTA, Kawasaki (JP); Takanori NAKAO, Kawasaki (JP); Yasuyuki MURATA, Shizuoka (JP)

(73) Assignee: FUJITSU LIMITED, Kawasaki-shi (JP)

(21) Appl. No.: 18/302,830

(22) Filed: Apr. 19, 2023

Related U.S. Application Data
(63) Continuation of application No. PCT/JP2020/046730, filed on Dec. 15, 2020.

(51) Int. Cl. H04N 19/172

(52) U.S. Cl. CPC H04N 19/172

(57) ABSTRACT

An analysis device includes: a memory; and a processor coupled to the memory and configured to: decide a first compression level based on a degree of influence of each area on a recognition result of a case where recognition processing is performed for each image data after a change in image quality; in a case where image data compressed at a second compression level according to the first compression level is decoded, perform the recognition processing for decoded data and calculate a recognition result; and determine at which compression level of the first compression level or the second compression level image data is compressed according to the calculated recognition result.

### CROSS-REFERENCE TO RELATED APPLICATION

This application is a continuation application of International Application PCT/JP2020/046730 filed on Dec. 15, 2020 and designated the U.S., the entire contents of which are incorporated herein by reference.

### FIELD

The embodiments discussed herein are related to an analysis device, an analysis method, and an analysis program.

### BACKGROUND

Generally, in a case where image data is recorded or transmitted, recording cost and transmission cost are reduced by reducing a data size by compression processing.

Japanese Laid-open Patent Publication No. 2018-101406, Japanese Laid-open Patent Publication No. 2019-079445, and Japanese Laid-open Patent Publication No. 2011-234033 are disclosed as related art.

### SUMMARY

According to an aspect of the embodiments, an analysis device includes: a memory; and a processor coupled to the memory and configured to: decide a first compression level based on a degree of influence of each area on a recognition result of a case where recognition processing is performed for each image data after a change in image quality; in a case where image data compressed at a second compression level according to the first compression level is decoded, perform the recognition processing for decoded data and calculate a recognition result; and determine at which compression level of the first compression level or the second compression level image data is compressed according to the calculated recognition result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a system configuration of a compression processing system;

FIG. 2 is a diagram illustrating an example of a hardware configuration of an analysis device or an image compression device;

FIG. 3 is a first diagram illustrating an example of a functional configuration of the analysis device;

FIG. 4 is a diagram illustrating a specific example of an aggregation result;

FIG. 5 is a first diagram illustrating a specific example of processing by a quantization value setting unit, an accuracy evaluation unit, and a quantization value determination unit;

FIG. 6 is a diagram illustrating an example of a functional configuration of the image compression device;

FIG. 7 is a first flowchart illustrating an example of a flow of compression processing by the compression processing system;

FIG. 8 is a second diagram illustrating an example of the functional configuration of the analysis device;

FIG. 9 is a second diagram illustrating specific examples of the processing by the quantization value setting unit, the accuracy evaluation unit, and the quantization value determination unit;

FIG. 10 is a second flowchart illustrating an example of the flow of the compression processing by the compression processing system;

FIG. 11 is a third diagram illustrating an example of the functional configuration of the analysis device;

FIG. 12 is a diagram illustrating a specific example of processing by a convolutional neural network (CNN) unit;

FIG. 13 is a diagram illustrating a specific example of the processing by the quantization value determination unit; and

FIG. 14 is a third flowchart illustrating an example of the flow of the compression processing by the compression processing system.

### DESCRIPTION OF EMBODIMENTS

Meanwhile, in recent years, there have been an increasing number of cases where image data is recorded or transmitted for the purpose of use in image recognition processing by artificial intelligence (AI). As a representative model of AI, for example, a model using deep learning or machine learning can be exemplified.

However, the existing compression processing is performed based on human visual characteristics and thus is not performed based on motion analysis of AI. For this reason, there have been cases where the compression processing is not performed at a sufficient compression level for an area that is not necessary for the image recognition processing by AI.

Meanwhile, if an attempt is made to analyze the area that is not necessary for the image recognition processing by AI before the compression processing using an analysis device or the like, it is assumed that an amount of calculation of the analysis device or the like increases.

In one aspect, an object is to implement compression processing suitable for image recognition processing by AI while suppressing an amount of calculation.

Hereinafter, each embodiment will be described with reference to the attached drawings. Note that, in the specification and the drawings, components having substantially the same functional configuration are denoted by the same reference numerals, and redundant description is omitted.

### First Embodiment

### System Configuration of Compression Processing System

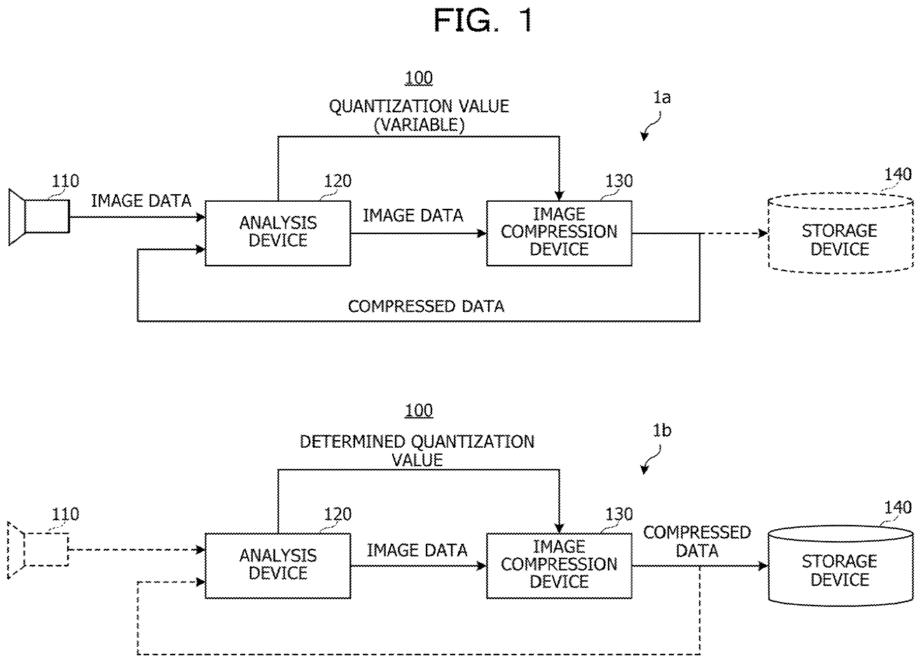

First, a system configuration of an entire compression processing system including an analysis device according to a first embodiment will be described. FIG. 1 is a first diagram illustrating an example of the system configuration of the compression processing system. In the first embodiment, processing executed by the compression processing system can be roughly divided into a phase of determining (a quantization value according to) a compression level and a phase of performing compression processing based on (the quantization value according to) the determined compression level.

In FIG. 1, reference numeral 1a denotes the system configuration of the compression processing system in the phase of determining (a quantization value corresponding to) a compression level. Furthermore, reference numeral 1b denotes the system configuration of the compression processing system in the phase of performing compression processing based on (the quantization value according to) the determined compression level.

As illustrated in 1a of FIG. 1, the compression processing system in the phase of determining (the quantization value according to) the compression level includes an imaging device 110, an analysis device 120, and an image compression device 130.

The imaging device 110 captures an image at a predetermined frame period and transmits image data to the analysis device 120. Note that the image data is assumed to include an object targeted for recognition processing.

The analysis device 120 includes a trained model for which the recognition processing is performed. The analysis device 120 performs the recognition processing by inputting the image data or decoded data (decoded data obtained by decoding compressed data of a case where the compression processing is performed for the image data at different compression levels) to the trained model and outputs a recognition result.

Furthermore, the analysis device 120 generates a map (referred to as an “important feature map”) indicating a degree of influence on the recognition result by performing motion analysis for the trained model using, for example, an error back propagation method, and aggregates the degree of influence for each predetermined area (for each block used when the compression processing is performed).

Note that the analysis device 120 repeats similar processing for the compressed data of a case of instructing the image compression device 130 to perform the compression processing at the different (quantization values according to a) predetermined number of compression levels and the compression processing is performed at each compression level. For example, the analysis device 120 aggregates the degree of influence of each block on the recognition result, for each image data after a change, while changing image quality of the image data.

Furthermore, the analysis device 120 decides (a quantization value corresponding to) an optimum compression level of each block from among the predetermined number of different compression levels based on a change in an aggregated value for (each quantization value corresponding to) each compression level. Note that (the quantization value corresponding to) the optimum compression level refers to (the quantization value corresponding to) the maximum compression level at which the recognition processing can be correctly performed for the object included in the image data among the predetermined number of different compression levels.

Furthermore, the analysis device 120 instructs the image compression device 130 to perform the compression processing at (the quantization value corresponding to) the compression level between the predetermined number of different compression levels and higher than the decided compression level.

Furthermore, the analysis device 120 outputs the recognition result by decoding the compressed data of the case where the compression processing is performed at the compression level higher than the decided compression level and inputting the decoded data to the trained model.

Moreover, the analysis device 120 finally determines whether to perform the compression processing at the decided compression level or to perform the compression processing at the compression level higher than the decided compression level according to whether the output recognition result is a predetermined allowable value or more.

Meanwhile, as illustrated in 1b of FIG. 1, the compression processing system in the phase of performing the compression processing based on (the quantization value corresponding to) the determined compression level includes the analysis device 120, the image compression device 130, and a storage device 140.

The analysis device 120 transmits (the quantization values corresponding to) the compression level determined for each block and the image data to the image compression device 130.

The image compression device 130 performs the compression processing for the image data, using (the quantization values according to) the determined compression level, and stores the compressed data in the storage device 140.

As described above, the analysis device 120 according to the present embodiment calculates the degree of influence of each block on the recognition result, and decides the compression level suitable for the recognition processing by the trained model from among the predetermined number of different compression levels. Thereby, it is possible to simplify the processing up to deciding the compression level suitable for the recognition processing (for example, it is possible to suppress the amount of calculation).

Furthermore, the analysis device 120 according to the present embodiment decides whether the compression processing at the compression level higher than the decided compression level is possible by comparing the recognition result with an allowable value (for example, the determination is made without generating the important feature map). Thereby, it is possible to simplify the processing up to deciding the availability of the higher compression level (for example, it is possible to suppress the amount of calculation).

As a result, according to the analysis device 120 of the present embodiment, it is possible to implement the compression processing suitable for the image recognition processing by AI while suppressing the amount of calculation.

### Hardware Configuration of Analysis Device and Image Compression Device

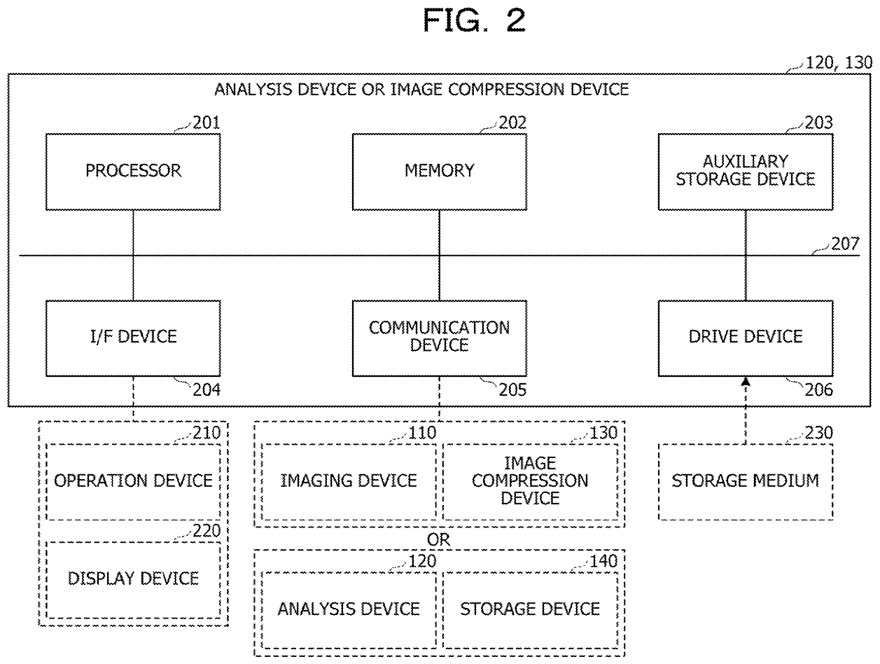

Next, a hardware configuration of the analysis device 120 and the image compression device 130 will be described. Note that, since the analysis device 120 and the image compression device 130 have similar hardware configurations, both the devices will be collectively described here with reference to FIG. 2.

FIG. 2 is a diagram illustrating an example of the hardware configuration of the analysis device or the image compression device. The analysis device 120 or the image compression device 130 includes a processor 201, a memory 202, an auxiliary storage device 203, an interface (I/F) device 204, a communication device 205, and a drive device 206. Note that the respective pieces of hardware of the analysis device 120 or the image compression device 130 are mutually coupled via a bus 207.

The processor 201 includes various arithmetic devices such as a central processing unit (CPU) or a graphics processing unit (GPU). The processor 201 reads various programs (for example, an analysis program or an image compression program or the like described later) into the memory 202 and executes the read programs.

The memory 202 includes a main storage device such as a read only memory (ROM) or a random access memory (RAM). The processor 201 and the memory 202 form a so-called computer. The processor 201 executes various programs read into the memory 202 so as to cause the computer to implement various functions (details of various functions will be described later).

The auxiliary storage device 203 stores various programs and various types of data used when the various programs are executed by the processor 201.

The I/F device 204 is a coupling device that couples an operation device 210 and a display device 220, which are examples of external devices, with the analysis device 120 or the image compression device 130. The I/F device 204 receives an operation for the analysis device 120 or the image compression device 130 via the operation device 210. Furthermore, the I/F device 204 outputs a result of processing by the analysis device 120 or the image compression device 130 and displays the result via the display device 220.

The communication device 205 is a communication device for communicating with another device. In the case of the analysis device 120, communication is performed with the imaging device 110 and the image compression device 130 via the communication device 205. Furthermore, in the case of the image compression device 130, communication is performed with the analysis device 120 and the storage device 140 via the communication device 205.

The drive device 206 is a device for setting a recording medium 230. The recording medium 230 mentioned here includes a medium that optically, electrically, or magnetically records information, such as a compact disc read only memory (CD-ROM), a flexible disk, or a magneto-optical disk. Furthermore, the recording medium 230 may include a semiconductor memory or the like that electrically records information, such as a ROM or a flash memory.

Note that the various programs to be installed in the auxiliary storage device 203 are installed, for example, by setting the distributed recording medium 230 in the drive device 206 and reading the various programs recorded in the recording medium 230 by the drive device 206. Alternatively, the various programs installed in the auxiliary storage device 203 may be installed by being downloaded from a network via the communication device 205.

### Functional Configuration of Analysis Device

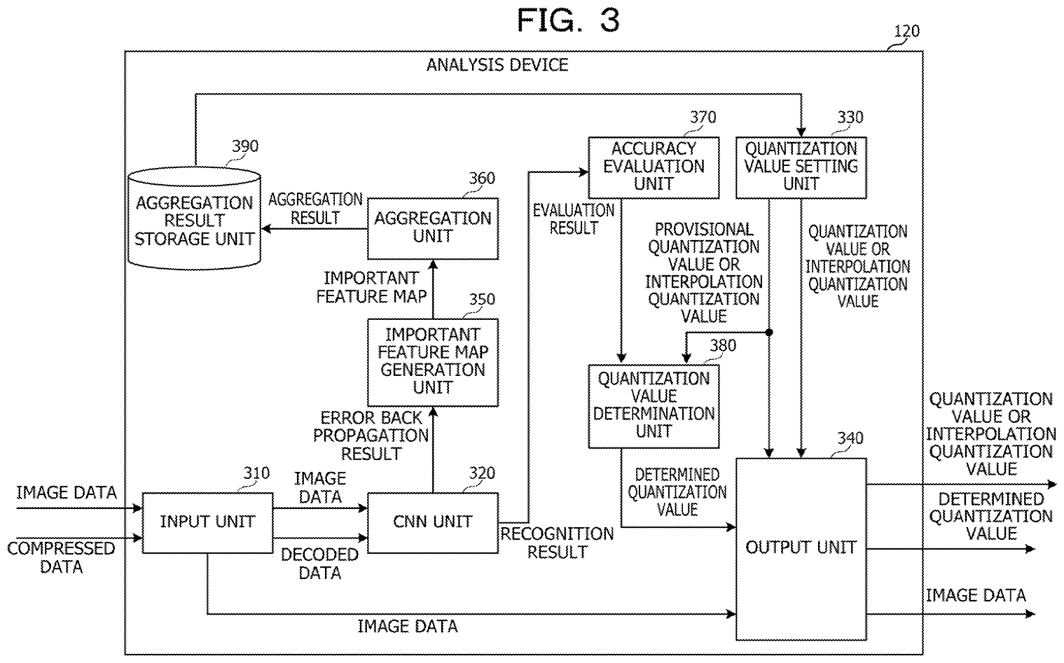

Next, a functional configuration of the analysis device 120 will be described. FIG. 3 is a first diagram illustrating an example of the functional configuration of the analysis device. As described above, the analysis program is installed in the analysis device 120, and when the program is executed, the analysis device 120 functions as an input unit 310, a CNN unit 320, a quantization value setting unit 330, and an output unit 340. Furthermore, the analysis device 120 functions as an important feature map generation unit 350, an aggregation unit 360, an accuracy evaluation unit 370, and a quantization value determination unit 380.

The input unit 310 acquires the image data transmitted from the imaging device 110 or the compressed data transmitted from the image compression device 130. The input unit 310 notifies the CNN unit 320 and the output unit 340 of the acquired image data. Furthermore, the input unit 310 decodes the acquired compressed data using a decoding unit (not illustrated), and notifies the CNN unit 320 of the decoded data.

The CNN unit 320 is an example of a calculation unit and has a trained model. The CNN unit 320 performs the recognition processing for the object included in the image data or the decoded data by inputting the image data or the decoded data, and outputs the recognition result.

The quantization value setting unit 330 is an example of a decision unit. The quantization value setting unit 330 sequentially notifies the output unit 340 of the quantization values according to a predetermined number of different compression levels (four types of compression levels in the present embodiment) to be used when the image compression device 130 performs the compression processing.

Furthermore, the quantization value setting unit 330 reads the aggregated values corresponding to the predetermined number of compression levels from an aggregation result storage unit 390 in response to the notification of the quantization values corresponding to the predetermined number of different compression levels to the output unit 340. Furthermore, the quantization value setting unit 330 decides an optimum compression level from among the predetermined number of different compression levels based on the read aggregated values. Furthermore, the quantization value setting unit 330 notifies the quantization value determination unit 380 of the quantization value (referred to as “provisional quantization value”) according to the decided optimum compression level (first compression level).

Moreover, the quantization value setting unit 330 notifies the output unit 340 and the quantization value determination unit 380 of the quantization value (referred to as an “interpolation quantization value”) according to a compression level (second compression level) between the predetermined number of different compression levels and higher than the decided optimum compression level.

The output unit 340 transmits the image data acquired by the input unit 310 to the image compression device 130. Furthermore, the output unit 340 sequentially transmits each quantization value (or interpolation quantization value) notified from the quantization value setting unit 330 to the image compression device 130. Moreover, the output unit 340 transmits the quantization value (referred to as “determined quantization value”) determined by the quantization value determination unit 380 to the image compression device 130.

The important feature map generation unit 350 is an example of a map generating unit, and generates the important feature map from the error calculated based on the recognition result when the trained model performs the recognition processing for the image data or the decoded data, using an error back propagation method.

The important feature map generation unit 350 generates the important feature map by using, for example, a back propagation (BP) method, a guided back propagation (GBP) method, or a selective BP method.

Note that the BP method is a method in which the error of each label is computed from a score obtained by performing the recognition processing for image data (or decoded data) whose recognition result is the correct answer label, and the feature portion is visualized by forming an image of the magnitude of a gradient obtained by back propagation to the input layer. Furthermore, the GBP method is a method of visualizing a feature portion by forming an image of only positive values of gradient information as the feature portion.

Moreover, the selective BP method is a method in which back propagation is performed using the BP method or the GBP method after maximizing only the errors of the correct answer labels. In a case of the selective BP method, a feature portion to be visualized is a feature portion that affects only the score of the correct answer label.

As described above, the important feature map generation unit 350 uses an error back propagation result by the error back propagation method such as the BP method, the GBP method, or the selective BP method. Therefore, the important feature map generation unit 350 analyzes a signal flow and intensity of each path in the CNN unit 320 from the input of the image data or the decoded data to the output of the recognition result. As a result, according to the important feature map generation unit 350, it is possible to visualize which area of the input image data or decoded data influences the recognition result to what extent.

Note that, for example, the method of generating the important feature map by the error back propagation method is disclosed in documents such as “Selvaraju, Ramprasaath R., et al., “Grad-cam: Visual explanations from deep networks via gradient-based localization”, The IEEE International Conference on Computer Vision (ICCV), 2017, pp. 618-626”.

The aggregation unit 360 aggregates the degree of influence of each area on the recognition result in units of blocks based on the important feature map and calculates the aggregated value of the degree of influence for each block. Furthermore, the aggregation unit 360 stores the calculated aggregated value of each block in the aggregation result storage unit 390 in association with the quantization value.

The accuracy evaluation unit 370

acquires the recognition result from the CNN unit 320, in the case where
the compression processing based on the interpolation quantization value is performed in the image compression device 130 when the interpolation quantization value is transmitted by the output unit 340,
the compressed data transmitted from the image compression device 130 is decoded by the input unit 310, and
the recognition result is output when the decoded data is input to the CNN unit 320 and the recognition processing is performed. Furthermore, the accuracy evaluation unit 370 evaluates whether the recognition result acquired from the CNN unit 320 is a predetermined allowable value or more, and notifies the quantization value determination unit 380 of the evaluation result.

The quantization value determination unit 380 is an example of a determination unit, and determines the determined quantization value based on the evaluation result notified from the accuracy evaluation unit 370 and notifies the output unit 340 of the determined quantization value. For example, in a case where the evaluation result that the recognition result is the predetermined allowable value or more is notified from the accuracy evaluation unit 370, the quantization value determination unit 380 determines the interpolation quantization value notified from the quantization value setting unit 330 as the determined quantization value and notifies the output unit 340 of the determined quantization value.

Meanwhile, in a case where the evaluation result that the recognition result is less than the predetermined allowable value is notified from the accuracy evaluation unit 370, the provisional quantization value notified from the quantization value setting unit 330 is determined as the determined quantization value and is notified to the output unit 340.

### Specific Example of Aggregation Result

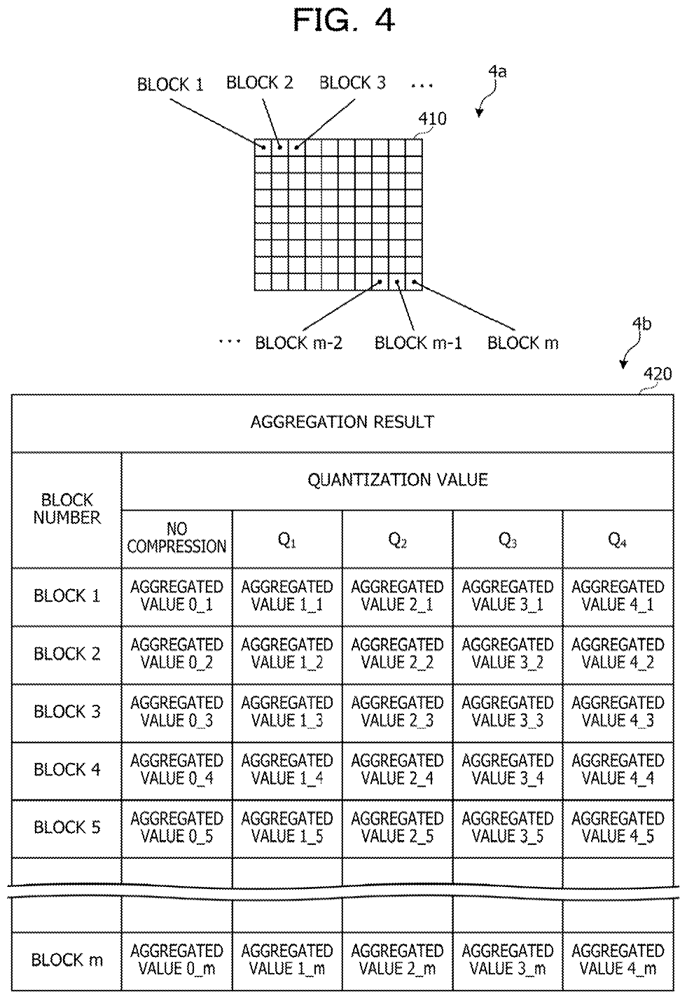

Next, a specific example of the aggregation result stored in the aggregation result storage unit 390 will be described. FIG. 4 is a diagram illustrating a specific example of the aggregation result. In FIG. 4, reference numeral 4a denotes an arrangement example of blocks in image data 410. As illustrated in 4a, in the present embodiment, it is assumed that all the blocks in the image data 410 have the same dimensions for the sake of simplification. Furthermore, in the example of 4a, the block number of the upper left block of the image data is assumed as “block 1”, and the block number of the lower right block is assumed as “block m”.

As illustrated in 4b, an aggregation result 420 includes “block number” and “quantization value” as information items.

In “block number”, a block number of each block in the image data 410 is stored. In “quantization value”, “no compression” indicating a case where the image compression device 130 does not perform the compression processing, and the quantization values (“Q₁” to “Q₄”) according to the four types of compression levels used when the image compression device 130 performs the compression processing are stored.

Furthermore, in the aggregation result 420, an area specified by “block number” and “quantization value” stores

the aggregated value obtained by:
performing the compression processing for the image data 410, using the corresponding quantization value, and
the trained model performing the recognition processing by inputting the decoded data obtained by decoding the acquired compressed data,
based on the important feature map calculated when the recognition processing has been performed.

### Specific Example of Processing by Quantization Value Setting Unit, Accuracy Evaluation Unit, and Quantization Value Determination Unit

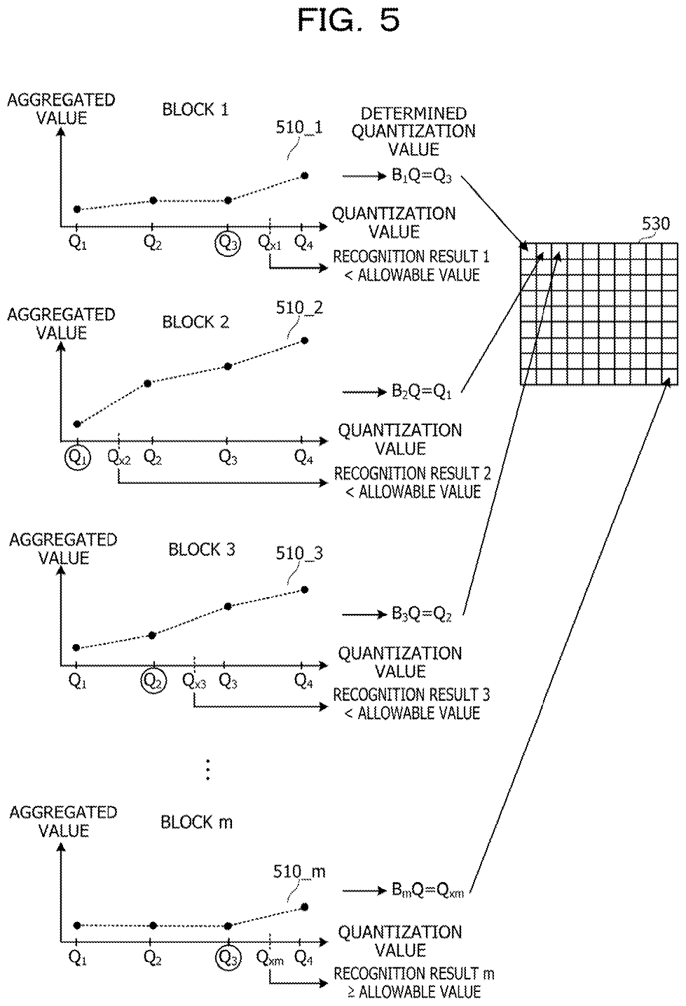

Next, a specific example of processing by the quantization value setting unit 330, the accuracy evaluation unit 370, and the quantization value determination unit 380 will be described. FIG. 5 is a first diagram illustrating a specific example of processing by the quantization value setting unit, the accuracy evaluation unit, and the quantization value determination unit. In FIG. 5, graphs 510_1 to 510_m are graphs generated by plotting the aggregated values of each block included in the aggregation result 420, with the quantization value on a horizontal axis and the aggregated value on a vertical axis.

As illustrated in graphs 510_1 to 510_m, the change in the aggregated value of the case where the compression processing is performed using the quantization values (“Q₁” to “Q₄”) according to the four types of compression levels is different for each block. The quantization value setting unit 330 decides, as a provisional quantization value of each block, the quantization value of a case where one of following conditions is satisfied:
a case where the magnitude of the aggregated value exceeds a predetermined threshold value;
a case where the amount of change in the aggregated value exceeds a predetermined threshold value;
a case where a slope of the aggregated value exceeds a predetermined threshold value; or
a case where the change in the slope of the aggregated value exceeds a predetermined threshold value, for example.

The example of FIG. 5 illustrates that the quantization value setting unit 330 decides the provisional quantization value=“Q₃” based on graph 510_1. Furthermore, the example of FIG. 5 illustrates that the quantization value setting unit 330 decides the provisional quantization value=“Q₁” based on graph 510_2. Furthermore, the example of FIG. 5 illustrates that the quantization value setting unit 330 decides the provisional quantization value=“Q₂” based on graph 510_3. Moreover, the example of FIG. 5 illustrates that the quantization value setting unit 330 decides the provisional quantization value=“Q₃” based on graph 510_m.

Furthermore, as illustrated in graphs 510_1 to 510_m, the interpolation quantization values (for example, the quantization values higher than the provisional quantization values) according to the compression levels among the four types of compression levels and higher than the optimum compression levels are transmitted to the image compression device 130. For example, Qₓ₁, Qₓ₂, Qₓ₃, . . . , and Qₓₘ are transmitted as the interpolation quantization values to the image compression device 130.

Thereby, the image compression device 130 performs the compression processing using the interpolation quantization values, and the CNN unit 320 performs the recognition processing for the decoded data obtained by decoding the compressed data. Furthermore, the accuracy evaluation unit 370 decides whether the recognition result is the allowable value or more, and the quantization value determination unit 380 determines the determined quantization value based on the decision result.

The example of FIG. 5 illustrates that the compression processing is performed with the interpolation quantization value=“Qₓ₁” and the recognition processing is performed for the decoded data obtained by decoding the compressed data, so that a recognition result 1 is output. Furthermore, the example illustrates that the output recognition result 1 is decided to be less than the allowable value, so that the provisional quantization value=“Q₃” is determined as the determined quantization value (B₁Q) for the block 1.

Furthermore, the example of FIG. 5 illustrates that the compression processing is performed with the interpolation quantization value=“Qₓ₂” and the recognition processing is performed for the decoded data obtained by decoding the compressed data, so that a recognition result 2 is output. Furthermore, the example illustrates that the output recognition result 2 is decided to be less than the allowable value, so that the provisional quantization value=“Q₁” is determined as the determined quantization value (B₂Q) for the block 2.

Furthermore, the example of FIG. 5 illustrates that the compression processing is performed with the interpolation quantization value=“Qₓ₃” and the recognition processing is performed for the decoded data obtained by decoding the compressed data, so that a recognition result 3 is output. Furthermore, the example illustrates that the output recognition result 3 is decided to be less than the allowable value, so that the provisional quantization value=“Q₂” is determined as the determined quantization value (B₃Q) for the block 3.

Moreover, the example of FIG. 5 illustrates that the compression processing is performed with the interpolation quantization value=“Qₓₘ” and the recognition processing is performed for the decoded data obtained by decoding the compressed data, so that a recognition result m is output. Furthermore, the example illustrates that the output recognition result m is decided to be the allowable value or more, so that the interpolation quantization value=“Qₓₘ” is determined as the determined quantization value (BₘQ) for the block 3.

In FIG. 5, reference numeral 530 denotes a state in which B₁Q to BₘQ are determined as the determined quantization values for the block 1 to block m and are set in the corresponding blocks.

Note that the size of the block at the time of aggregation and the size of the block used for the compression processing do not have to match. In that case, for example, the quantization value determination unit 380 determines the quantization value as follows.
In a case where the size of the block used for the compression processing is larger than the size of the block at the time of aggregation,

an average value (alternatively, a minimum value, a maximum value, or a value modified with another index) of the quantization values based on the aggregated values of each block at the time of aggregation contained in the block used for the compression processing is adopted as the quantization value of each block used for the compression processing.
In a case where the size of the block used for the compression processing is smaller than the size of the block at the time of aggregation,

the quantization value based on the aggregated values of the block at the time of aggregation is used as the quantization value of each block used for the compression processing contained in the block at the time of aggregation.

### Functional Configuration of Image Compression Device

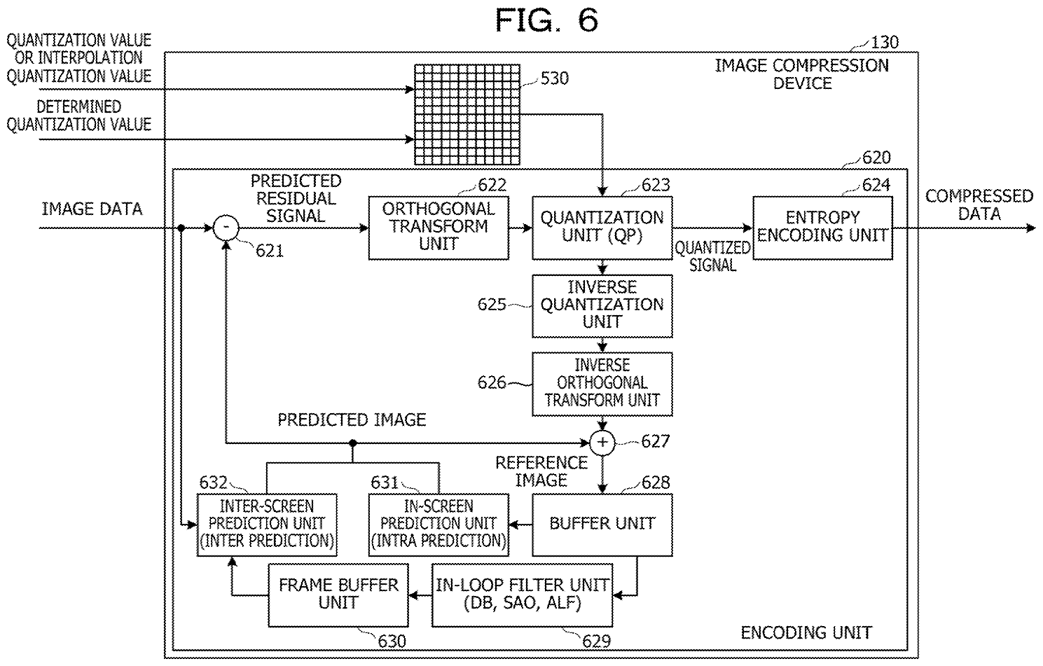

Next, a functional configuration of the image compression device 130 will be described. FIG. 6 is a diagram illustrating an example of the functional configuration of the image compression device; As described above, an image compression program is installed in the image compression device 130, and when the program is executed, the image compression device 130 functions as an encoding unit 620.

The encoding unit 620 is an example of a compression unit. The encoding unit 620 includes a difference unit 621, an orthogonal transform unit 622, a quantization unit 623, an entropy encoding unit 624, an inverse quantization unit 625, and an inverse orthogonal transform unit 626. Furthermore, the encoding unit 620 includes an addition unit 627, a buffer unit 628, an in-loop filter unit 629, a frame buffer unit 630, an in-screen prediction unit 631, and an inter-screen prediction unit 632.

The difference unit 621 calculates a difference between the image data (for example, the image data 410) and predicted image data and outputs a predicted residual signal.

The orthogonal transform unit 622 executes orthogonal transform processing for the predicted residual signal output by the difference unit 621.

The quantization unit 623 quantizes the predicted residual signal that has undergone the orthogonal transform processing to generate a quantized signal. The quantization unit 623 generates the quantized signal using the quantization values illustrated in reference numeral 530 (the quantization values transmitted by the analysis device 120 (the quantization values or interpolation quantization values according to the four types of compression levels) or the determined quantization values).

The entropy encoding unit 624 generates the compressed data by performing entropy encoding processing for the quantized signal.

The inverse quantization unit 625 inversely quantizes the quantized signal. The inverse orthogonal transform unit 626 executes inverse orthogonal transform processing for the inversely quantized signal.

The addition unit 627 generates reference image data by adding the signal output from the inverse orthogonal transform unit 626 and the predicted image data. The buffer unit 628 stores the reference image data generated by the addition unit 627.

The in-loop filter unit 629 performs filter processing for the reference image data stored in the buffer unit 628. The in-loop filter unit 629 includes

a deblocking filter (DB),

a sample adaptive offset filter (SAO), and

an adaptive loop filter (ALF).

The frame buffer unit 630 stores the reference image data for which the filter processing has been performed by the in-loop filter unit 629 in units of frames.

The in-screen prediction unit 631 performs in-screen prediction based on the reference image data and generates the predicted image data. The inter-screen prediction unit 632 performs motion compensation between frames using the input image data (for example, the image data 410) and the reference image data and generates the predicted image data.

Note that the predicted image data generated by the in-screen prediction unit 631 or the inter-screen prediction unit 632 is output to the difference unit 621 and the addition unit 627.

Note that, in the above description, it is assumed that the encoding unit 620 performs the compression processing using an existing moving image encoding method such as MPEG-2, MPEG-4, H.264, or HEVC. However, the compression processing by the encoding unit 620 is not limited to these moving image encoding methods and may be performed using any encoding method in which a compression rate is controlled by parameters of quantization or the like.

### Flow of Compression Processing by Compression Processing System

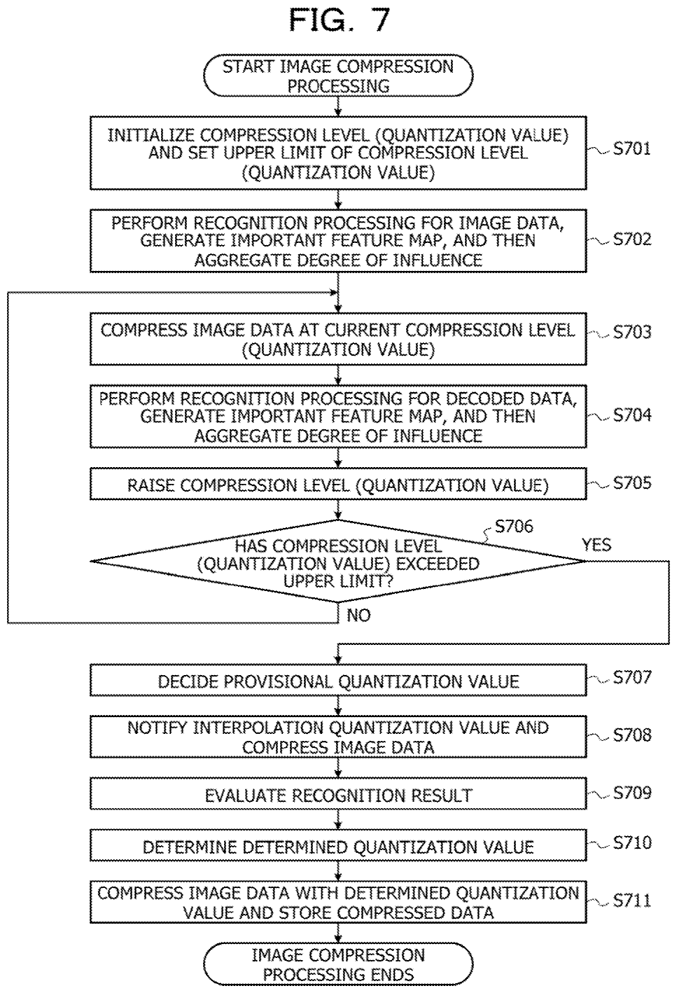

Next, a flow of the compression processing by a compression processing system 100 will be described. FIG. 7 is a first flowchart illustrating an example of the flow of the compression processing by the compression processing system.

In step S701, the quantization value setting unit 330 initializes the compression level (sets the quantization value (Q₁)) and also sets an upper limit of the compression level (quantization value (Q₄)).

In step S702, the input unit 310 acquires the image data in units of frames, and the CNN unit 320 performs the recognition processing for the image data. Furthermore, the important feature map generation unit 350 generates the important feature map, and the aggregation unit 360 aggregates the degree of influence of each area in units of blocks and stores the aggregation result in the aggregation result storage unit 390.

In step S703, the output unit 340 transmits the image data and (the quantization value according to) the current compression level to the image compression device 130. Furthermore, the image compression device 130 performs the compression processing for the transmitted image data with (the quantization value according to) the current compression level and generates the compressed data.

In step S704, the input unit 310 acquires the compressed data and decodes the acquired compressed data to generate the decoded data. Furthermore, the CNN unit 320 performs the recognition processing for the decoded data. Furthermore, the important feature map generation unit 350 generates the important feature map, and the aggregation unit 360 aggregates the degree of influence of each area in units of blocks and stores the aggregation result in the aggregation result storage unit 390.

In step S705, the quantization value setting unit 330 raises the compression level (here, sets the quantization value (Q₂).

In step S706, the quantization value setting unit 330 decides whether the current compression level has exceeded the upper limit (whether the current quantization value has exceeded the maximum quantization value (Q₄)). In a case where it is decided that the current compression level does not exceed the upper limit in step S706 (in the case of No in step S706), the processing returns to step S703.

On the other hand, in a case where it is decided that the current compression level exceeds the upper limit in step S706 (in the case of Yes in step S706), the processing proceeds to step S707.

In step S707, the quantization value setting unit 330 decides the provisional quantization value according to the optimum compression level in units of blocks based on the aggregation result stored in the aggregation result storage unit 390.

In step S708, the quantization value setting unit 330 notifies the output unit 340 of the interpolation quantization value higher than the decided provisional quantization value, and the output unit 340 transmits the interpolation quantization value to the image compression device 130. Furthermore, the image compression device 130 performs the compression processing for the image data using the interpolation quantization value to generate the compressed data.

In step S709, the input unit 310 acquires the compressed data and decodes the acquired compressed data to generate the decoded data. Furthermore, the CNN unit 320 performs the recognition processing for the decoded data. Furthermore, the accuracy evaluation unit 370 evaluates whether the recognition result is a predetermined allowable value or more.

In step S710, the quantization value determination unit 380 determines the determined quantization value based on the evaluation result and transmits the determined quantization value to the image compression device 130.

In step S711, the image compression device 130 compresses the image data with the determined quantization value and stores the compressed data in the storage device 140.

As is clear from the above description, the analysis device according to the first embodiment acquires each compressed data of the case where the compression processing is performed for the image data using (the quantization values according to) a predetermined number of different compression levels. Furthermore, the analysis device according to the first embodiment performs the recognition processing for the decoded data obtained by decoding each compressed data, and generates the important feature map indicating the degree of influence of each area on the recognition result from the error calculated based on the recognition result by using the error back propagation method. Furthermore, the analysis device according to the first embodiment aggregates the degree of influence in units of blocks based on the important feature map, and decides the provisional quantization value according to the optimum compression level of each block of the image data based on the aggregated value of each block corresponding to a predetermined number of different compression levels. Furthermore, the analysis device according to the first embodiment performs the compression processing using the interpolation quantization value according to the compression level between the predetermined number of different compression levels and higher than the decided compression level, and acquires the compressed data. Furthermore, the analysis device according to the first embodiment determines either the provisional quantization value or the interpolation quantization value as the determined quantization value according to whether the recognition result of the decoded data obtained by decoding the acquired compressed data is the allowable value or more.

As described above, the analysis device according to the first embodiment decides (the provisional quantization value according to) the compression level suitable for the recognition processing from among the predetermined number of different compression levels. Thereby, it is possible to simplify the processing up to deciding the compression level suitable for the recognition processing. Furthermore, the analysis device according to the first embodiment decides whether the compression processing at the compression level higher than the decided compression level is possible by comparing the recognition result with the allowable value (for example, without generating the important feature map). Thereby, it is possible to simplify the processing up to deciding availability of a higher compression level.

As a result, according to the first embodiment, it is possible to implement the compression processing suitable for the image recognition processing by AI while suppressing the amount of calculation.

### Second Embodiment

In the above-described first embodiment, the case of performing the compression processing using the quantization values according to the four types of different compression levels in determining the determined quantization value based on the degree of influence on the recognition result has been described.

In contrast, in a second embodiment, a case of determining a determined quantization value by performing compression processing using predetermined one type of quantization value will be described. Hereinafter, regarding the second embodiment, differences from the above-described first embodiment will be mainly described.

### Functional Configuration of Analysis Device

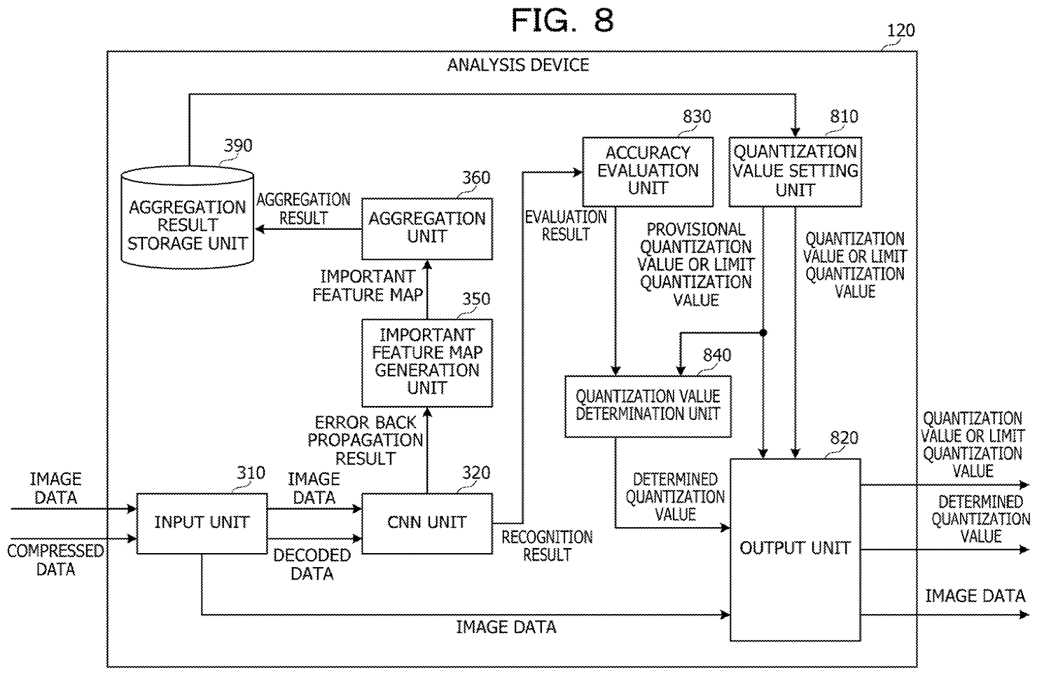

First, a functional configuration of an analysis device 120 according to the second embodiment will be described. FIG. 8 is a second diagram illustrating an example of the functional configuration of the analysis device. Differences from the functional configuration illustrated in FIG. 3 are that functions of a quantization value setting unit 810, an output unit 820, an accuracy evaluation unit 830, and a quantization value determination unit 840 are different from the functions of the quantization value setting unit 330, the output unit 340, the accuracy evaluation unit 370, and the quantization value determination unit 380.

The quantization value setting unit 810 is another example of the decision unit, and notifies the output unit 820 of a quantization value (Qₙ) according to predetermined one type of compression level. Furthermore, the quantization value setting unit 810 reads an aggregated value corresponding to the predetermined one type of compression level from an aggregation result storage unit 390 in response to the notification of the quantization value according to the predetermined one type of compression level to the output unit 820. Furthermore, the quantization value setting unit 810 decides a group to which the read aggregated value belongs, and notifies the quantization value determination unit 840 of the quantization value according to an optimum compression level (first compression level) associated in advance with the decided group as a provisional quantization value.

Furthermore, the quantization value setting unit 810 notifies the output unit 820 of a quantization value (referred to as a “limit quantization value” different from the provisional quantization value) according to a compression level (second compression level) different from the optimum compression level associated in advance with each group.

The output unit 820 transmits image data acquired by an input unit 310 to an image compression device 130. Furthermore, the output unit 820 transmits the quantization value (Qₙ) according to the predetermined one type of compression level notified from the quantization value setting unit 810 to the image compression device 130. Furthermore, the output unit 820 transmits the limit quantization value notified from the quantization value setting unit 810 to the image compression device 130. Moreover, the output unit 820 transmits the determined quantization value determined by the quantization value determination unit 840 to the image compression device 130.

The accuracy evaluation unit 830 acquires a recognition result from a CNN unit 320, in a case where
compression processing based on a limit quantization value is performed in the image compression device 130 when the limit quantization value is transmitted by the output unit 820,
compressed data transmitted from the image compression device 130 is decoded by the input unit 310, and
the recognition result is output when decoded data is input to the CNN unit 320 and recognition processing is performed. Furthermore, the accuracy evaluation unit 830 evaluates whether the recognition result acquired from the CNN unit 320 is a predetermined allowable value or more, and notifies the quantization value determination unit 840 of an evaluation result.

The quantization value determination unit 840 is another example of the determination unit, and determines the determined quantization value based on the evaluation result notified from the accuracy evaluation unit 830 and notifies the output unit 820 of the determined quantization value. For example, in a case where the evaluation result that the recognition result is the predetermined allowable value or more is notified from the accuracy evaluation unit 830, the quantization value determination unit 840 determines the limit quantization value notified from the quantization value setting unit 810 as the determined quantization value and notifies the output unit 820 of the determined quantization value.

Meanwhile, in a case where the evaluation result that the recognition result is less than the predetermined allowable value is notified from the accuracy evaluation unit 830, the provisional quantization value notified from the quantization value setting unit 810 is determined as the determined quantization value and is notified to the output unit 820.

### Specific Example of Processing by Quantization Value Setting Unit, Accuracy Evaluation Unit, and Quantization Value Determination Unit

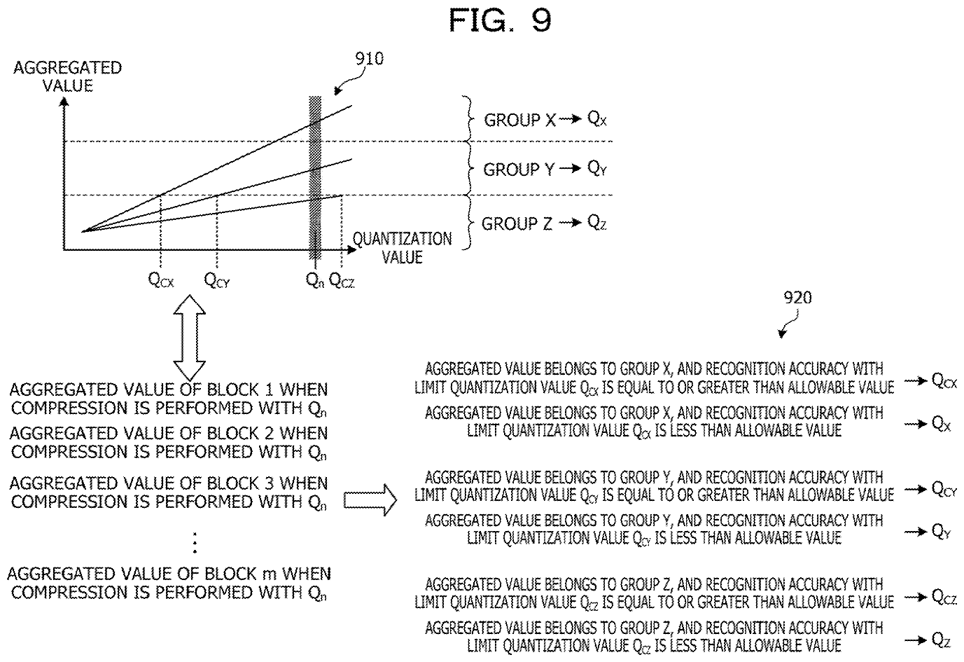

Next, a specific example of processing by the quantization value setting unit 810, the accuracy evaluation unit 830, and the quantization value determination unit 840 will be described. FIG. 9 is a second diagram illustrating specific examples of processing by the quantization value setting unit, the accuracy evaluation unit, and the quantization value determination unit. In FIG. 9, graph 910 is a graph illustrating three patterns in which a horizontal axis represents the quantization value and a vertical axis represents the aggregated value, and a change in the aggregated value with respect to a change in the quantization value is illustrated. Here, the change in the aggregated value to the change in the quantization value has the following properties.
In the case of a block in which a low compression level is estimated to be the optimum compression level, the graph rises at a low compression level, and the aggregated value in the case of setting a high compression level is large (see group X).
In the case of a block in which a medium compression level is estimated to be the optimum compression level, the graph rises at a medium compression level, and the aggregated value in the case of setting a high compression level is medium (see group Y).
In the case of a block in which a high compression level is estimated to be the optimum compression level, the graph rises at a high compression level, and the aggregated value in the case of setting a high compression level is small (see group Z).

The example of FIG. 9 illustrates a state in which the quantization value setting unit 810 reads the aggregated value of each block corresponding to the predetermined one type of compression level from the aggregation result storage unit 390 in response to the notification of the quantization value (Qₙ) according to the predetermined one type of compression level to the output unit 820. Thereby, the quantization value setting unit 810 can decide which group each block belongs to, and can decide the provisional quantization value of each block.

In the case of the example of FIG. 9, in the case where it is decided to belong to the group X, the provisional quantization value=“Q_{X}” is decided. Furthermore, in the case where it is decided to belong to the group Y, the provisional quantization value=“Q_{Y}” is decided. Furthermore, in the case where it is decided to belong to the group Z, the provisional quantization value=“Q_{Z}” is decided.

Furthermore, the example of FIG. 9 illustrates that “Q_{CX}” is set for the block decided to belong to the group X as the limit quantization value at which the decoded data has predetermined image quality. Furthermore, the example illustrates that “Q_{CY}” is set for the block decided to belong to the group Y as the limit quantization value at which the decoded data has predetermined image quality. Moreover, the example illustrates that “Q_{CZ}” is set for the block decided to belong to the group Z as the limit quantization value at which the decoded data has predetermined image quality.

As described above, after the limit quantization value is transmitted to the image compression device 130, the compression processing based on the limit quantization value is performed, and the compressed data is transmitted to the analysis device 120. Furthermore, the compressed data undergoes the recognition processing by being input to the CNN unit 320 after being decoded by the input unit 310. Moreover, the accuracy evaluation unit 830 evaluates whether the recognition result is the allowable value or more.

In FIG. 9, reference numeral 920 denotes specific examples of a method of determining the determined quantization value by the quantization value determination unit 840. As illustrated with reference numeral 920 in FIG. 9, in the case of the block with the aggregated value belonging to the group X,
In the case where the recognition result corresponding to the limit quantization value=“Q_{CX}” is evaluated to be the allowable value or more, the quantization value determination unit 840 determines the limit quantization value=“Q_{CX}” as the determined quantization value.
In the case where the recognition result corresponding to the limit quantization value=“Q_{CX}” is evaluated to be less than the allowable value, the quantization value determination unit 840 determines the provisional quantization value=“Q_{X}” as the determined quantization value.

Furthermore, as illustrated with reference numeral 920 in FIG. 9, in the case of the block with the aggregated value belonging to the group Y,
In the case where the recognition result corresponding to the limit quantization value=“Q_{CY}” is evaluated to be the allowable value or more, the quantization value determination unit 840 determines the limit quantization value=“Q_{CY}” as the determined quantization value.
In the case where the recognition result corresponding to the limit quantization value=“Q_{CY}” is evaluated to be less than the allowable value, the quantization value determination unit 840 determines the provisional quantization value=“Q_{Y}” as the determined quantization value.

Furthermore, as illustrated with reference numeral 920 in FIG. 9, in the case of the block with the aggregated value belonging to the group Z,
In the case where the recognition result corresponding to the limit quantization value=“Q_{CZ}” is evaluated to be the allowable value or more, the quantization value determination unit 840 determines the limit quantization value=“Q_{CZ}” as the determined quantization value.
In the case where the recognition result corresponding to the limit quantization value=“Q_{CZ}” is evaluated to be less than the allowable value, the quantization value determination unit 840 determines the provisional quantization value=“Q_{Z}” as the determined quantization value.

### Flow of Compression Processing by Compression Processing System

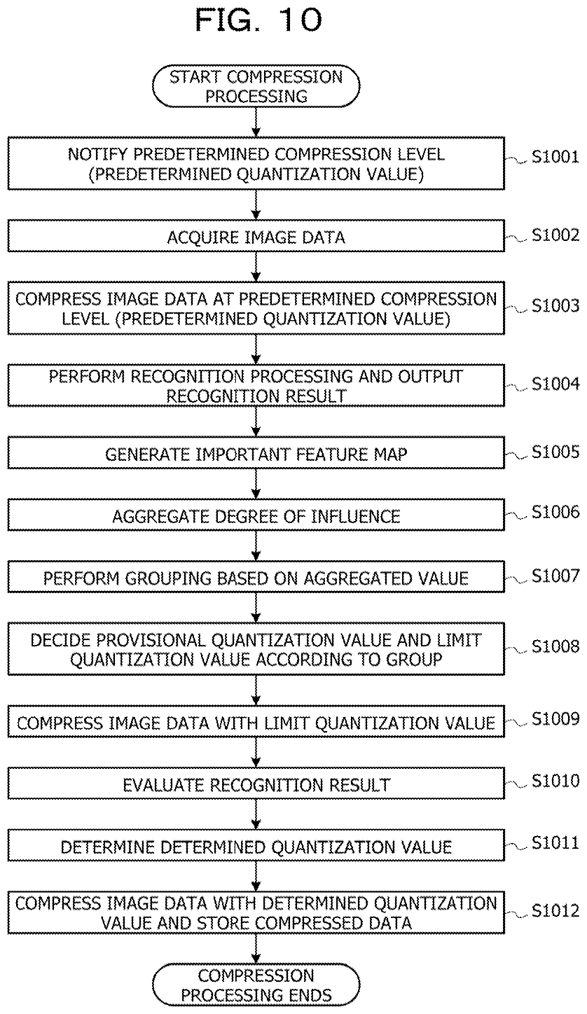

Next, a flow of the compression processing by a compression processing system 100 will be described. FIG. 10 is a second flowchart illustrating an example of a flow of the compression processing by the compression processing system.

In step S1001, the quantization value setting unit 810 notifies the output unit 820 of the quantization value (Qₙ) according to predetermined one type of compression level.

In step S1002, the input unit 310 acquires image data in units of frames.

In step S1003, the output unit 820 transmits the image data and the quantization value (Qₙ) according to the predetermined one type of compression level to the image compression device 130. Furthermore, the image compression device 130 performs the compression processing for the transmitted image data, using the quantization value (Qₙ) according to the predetermined one type of compression level, and generates compressed data.

In step S1004, the input unit 310 acquires and decodes the compressed data generated by the image compression device 130. Furthermore, the CNN unit 320 performs the recognition processing for the decoded data and outputs the recognition result.

In step S1005, an important feature map generation unit 350 generates an important feature map indicating a degree of influence of each area on the recognition result by using an error back propagation method from an error calculated based on the recognition result.

In step S1006, an aggregation unit 360 aggregates the degree of influence of each area on the recognition result in units of blocks based on the important feature map. Furthermore, the aggregation unit 360 stores the aggregated values in the aggregation result storage unit 390.

In step S1007, the quantization value setting unit 810 decides which group the aggregated value of each block stored in the aggregation result storage unit 390 belongs to. Thereby, the quantization value setting unit 810 groups each of the blocks.

In step S1008, the quantization value setting unit 810 notifies the quantization value determination unit 840 of the quantization value (provisional quantization value) according to the optimum compression level associated with each decided group for each block. Furthermore, the quantization value setting unit 810 notifies the output unit 820 of the limit quantization value associated with each decided group for each block.

In step S1009, the output unit 820 transmits the limit quantization value to the image compression device 130. Furthermore, the image compression device 130 generates compressed data by performing the compression processing using the limit quantization value and transmits the compressed data to the analysis device 120.

In step S1010, the input unit 310 decodes the compressed data transmitted from the image compression device 130. Furthermore, the CNN unit 320 performs the recognition processing for the decoded data. Moreover, the accuracy evaluation unit 830 evaluates whether the recognition result is a predetermined allowable value or more.

In step S1011, the quantization value determination unit 840 determines the determined quantization value for each block based on whether the recognition result is the predetermined allowable value or more.

In step S1012, the image compression device 130 performs the compression processing for the image data, using the determined quantization value, and stores the compressed data in a storage device 140.

As is clear from the above description, the analysis device according to the second embodiment acquires the compressed data of the case where the compression processing is performed for the image data using (the quantization values according to) the predetermined one type of compression level. Furthermore, the analysis device according to the second embodiment generates the important feature map indicating the degree of influence of each area on the recognition result by using the error back propagation method from the error calculated based on the recognition result of the case of performing the recognition processing for the decoded data obtained by decoding the compressed data. Furthermore, the analysis device according to the second embodiment decides the provisional quantization value associated with a group by aggregating the degree of influence in units of blocks based on the important feature map, and deciding the group to which the aggregated value belongs. Furthermore, the analysis device according to the second embodiment acquires the compressed data of the case where the compression processing is performed using the limit quantization value different from the provisional quantization value associated with the group. Furthermore, the analysis device according to the second embodiment determines either the provisional quantization value or the limit quantization value as the determined quantization value according to whether the recognition result of the decoded data obtained by decoding the acquired compressed data is the allowable value or more.

As described above, the analysis device according to the second embodiment groups the image data in units of blocks by performing the compression processing for the image data at the predetermined one type of compression level, and decides (the provisional quantization value according to) the compression level suitable for the recognition processing. Thereby, it is possible to simplify the processing up to deciding the compression level suitable for the recognition processing. Furthermore, the analysis device according to the second embodiment decides whether the compression processing with the limit quantization value associated in advance for each group is possible by comparing the recognition result with the allowable value (for example, without generating the important feature map). Thereby, it is possible to simplify the processing up to deciding availability of a higher compression level.

As a result, according to the second embodiment, it is possible to implement the compression processing suitable for the image recognition processing by AI while suppressing the amount of calculation.

### Third Embodiment

In the above-described first embodiment, the case of performing the compression processing using the quantization values corresponding to the four types of compression levels has been described. However, the types of compression levels used when the compression processing is performed are not limited to four types. For example, assuming that the number of quantization values settable in the image compression device 130 is fifty one, the compression processing may be performed using quantization values according to twenty-six types of compression levels (for example, by using every other quantization value). As a result, a determined quantization value can be determined with accuracy at an equivalent level to the case of performing the compression processing using fifty-one quantization values.

Furthermore, in the above-described first embodiment, the case of performing the compression processing using one type of interpolation quantization value has been described. However, the number of types of interpolation quantization values used when the compression processing is performed is not limited to one type, and may be a plurality of types.

As described above, the number of types of compression levels and the number of types of interpolation quantization values are assumed to be arbitrarily determined according to how to design the amount of calculation of the entire compression processing system 100.

Furthermore, in the above-described first and second embodiments, it has been described that one of the provisional quantization value and the interpolation quantization value or one of the provisional quantization value and the limit quantization value is determined as the determined quantization value. However, the method for determining the determined quantization value is not limited thereto. For example, when the determined quantization value is determined, the determined quantization value may be determined after selecting one of the provisional quantization value and the interpolation quantization value or one of the provisional quantization value and the limit quantization value, and performing fine adjustment for the selected quantization value according to the important feature map.

Furthermore, in the above-described second embodiment, it has been described that the limit quantization value is a value larger than the provisional quantization value, but the limit quantization value may be a value smaller than the provisional quantization value. Alternatively, the compression processing may be performed using both the limit quantization value larger than the provisional quantization value and the limit quantization value smaller than the provisional quantization value and evaluate the recognition result.

In the above-described first and second embodiments, it has been described that one object targeted for the recognition processing is included in the image data. However, the image data may include a plurality of objects targeted for the recognition processing, and in this case, the recognition result may be different for each object.

In such a case, the quantization value determination units 380 and 840 are assumed to decide in which object each block is included, and determine the determined quantization value according to the recognition result of the decided object.

### Fourth Embodiment

In the above-described first to third embodiments, the case of reducing the amount of calculation in the analysis device 120 when determining the determined quantization value by simplifying the processing up to deciding the compression level suitable for the recognition processing (alternatively, processing up to deciding availability of a higher compression level) has been described. In contrast, in a fourth embodiment, a case of reducing an amount of calculation in an analysis device 120 when determining a determined quantization value by simplifying processing in a CNN unit will be described. Hereinafter, regarding the fourth embodiment, differences from the above-described first to third embodiments will be mainly described.

### Functional Configuration of Analysis Device

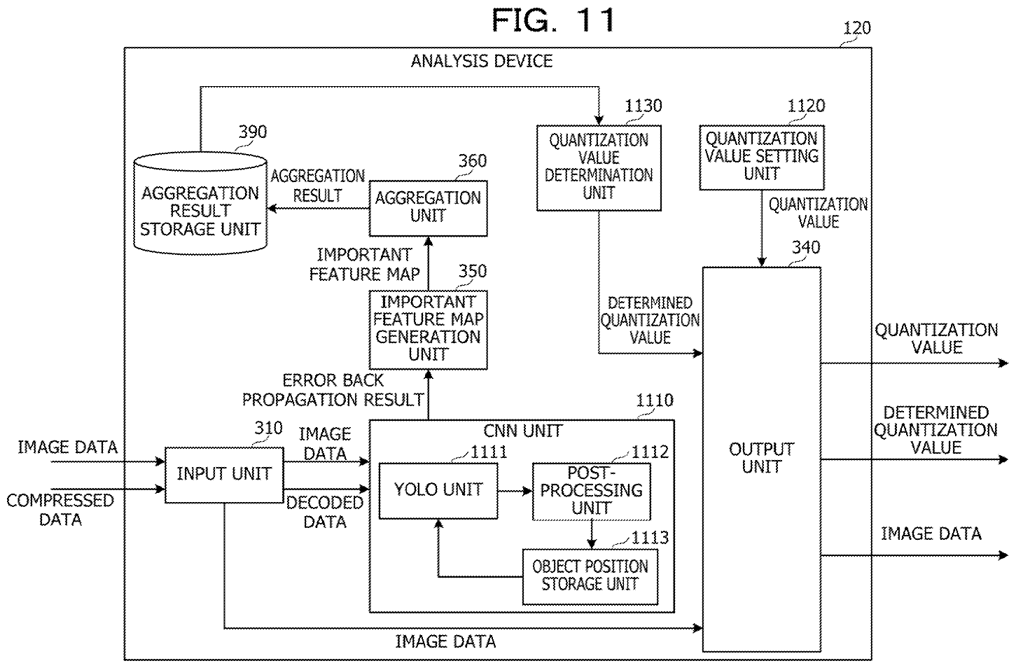

First, a functional configuration of an analysis device 120 according to the fourth embodiment will be described. FIG. 11 is a third diagram illustrating an example of the functional configuration of the analysis device. Differences from the functional configuration illustrated in FIG. 3 are that functions of a CNN unit 1110, a quantization value setting unit 1120, and a quantization value determination unit 1130 are different from the functions of the CNN unit 320, the quantization value setting unit 330, and the quantization value determination unit 380.

The CNN unit 1110 includes a you only look once (YOLO) unit 1111, a post-processing unit 1112, and an object position storage unit 1113.

The YOLO unit 1111 is an example of a first calculation unit and is a trained YOLO model, and calculates a score of each cell of image data or decoded data (a score for each object obtained by performing recognition processing) by inputting the image data or the decoded data.

Furthermore, the YOLO unit 1111 calculates an error for each object, of the score of each cell calculated by inputting the decoded data, and back-propagates the calculated error. Thereby, an important feature map generation unit 350 can generate an important feature map indicating a degree of influence of each cell on a recognition result.

Note that, when calculating the error, the YOLO unit 1111 uses the score of each cell calculated by inputting image data to the YOLO unit 1111. Furthermore, when calculating the error for each object, the YOLO unit 1111 reads information indicating a position of the object recognized by the post-processing unit 1112 from the object position storage unit 1113 based on the score of each cell calculated by inputting the image data, and uses the information.

The post-processing unit 1112 is an example of a specifying unit, and specifies the position of each object included in the image data based on the score of each cell output by inputting the image data to the YOLO unit 1111. Furthermore, the post-processing unit 1112 stores the information indicating the specified position of each object in the object position storage unit 1113.

As described above, the CNN unit 1110 acquires the information indicating the position of each object to be used for calculating the error for each object by reading the information from the object position storage unit 1113 without operating the post-processing unit 1112. For example, the processing in the CNN unit 1110 is simplified. Thereby, it is possible to reduce the amount of calculation when the important feature map generation unit 350 (an example of a second calculation unit) generates the important feature map by back-propagating the error.

The quantization value setting unit 1120 sequentially notifies an output unit 340 of quantization values according to a plurality of compression levels (fifty-one types of settable compression levels in the present embodiment) to be used when an image compression device 130 performs compression processing.

The quantization value determination unit 1130 is another example of the determination unit, and reads aggregated values corresponding to the plurality of compression levels from an aggregation result storage unit 390 in response to notification of the quantization values according to the plurality of compression levels stored in the aggregation result storage unit 390 to the output unit 340. Furthermore, the quantization value determination unit 1130 determines a determined quantization value that is a quantization value according to an optimum compression level based on the read aggregated values. Furthermore, the quantization value determination unit 1130 notifies the output unit 340 of the determined quantization value determined.

### Specific Example of Processing by CNN Unit

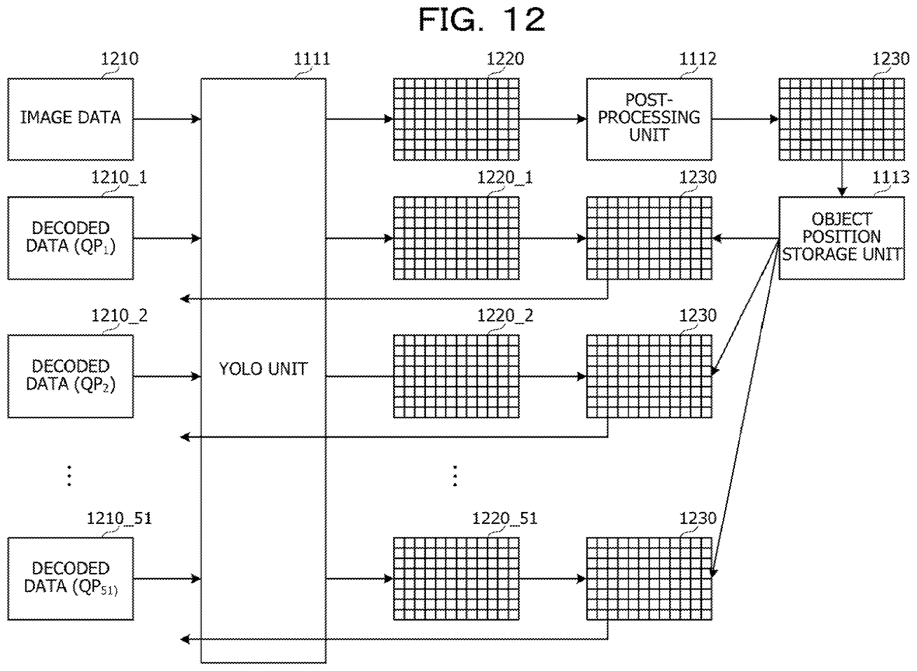

Next, a specific example of processing by the CNN unit 1110 will be described. FIG. 12 is a diagram illustrating a specific example of processing by the CNN unit. As illustrated in FIG. 12, when image data 1210 is input, the YOLO unit 1111 calculates a score 1220 of each cell. Furthermore, the calculated score 1220 of each cell is input to the post-processing unit 1112, and the post-processing unit 1112 specifies a position 1230 of the object included in the image data 1210. Furthermore, the post-processing unit 1112 stores information indicating the specified position 1230 of the object in the object position storage unit 1113.

Next, when decoded data 1210_1 (decoded data obtained by decoding compressed data that has undergone the compression processing using a quantization value=QP₁) is input, the YOLO unit 1111 calculates a score 1220_1 of each cell. Furthermore, the YOLO unit 1111 calculates an error between the calculated score 1220_1 of each cell and the calculated score 1220 of each cell for each object based on the information indicating the position 1230 of each object stored in the object position storage unit 1113. Moreover, the YOLO unit 1111 back-propagates the calculated error for each object. Thereby, the important feature map generation unit 350 can generate the important feature map for the decoded data 1210_1.

Next, when decoded data 1210_2 (decoded data obtained by decoding compressed data that has undergone the compression processing using a quantization value=QP₂) is input, the YOLO unit 1111 calculates a score 1220_2 of each cell. Furthermore, the YOLO unit 1111 calculates an error between the calculated score 1220_2 of each cell and the calculated score 1220 of each cell for each object based on the information indicating the position 1230 of each object stored in the object position storage unit 1113. Moreover, the YOLO unit 1111 back-propagates the calculated error for each object. Thereby, the important feature map generation unit 350 can generate the important feature map for the decoded data 1210_2.

The CNN unit 1110 repeats the above-described processing up to decoded data 1210_51. Thereby, the important feature map generation unit 350 can generate the important feature map for the decoded data 1210_51.

### Specific Example of Processing by Quantization Value Determination Unit

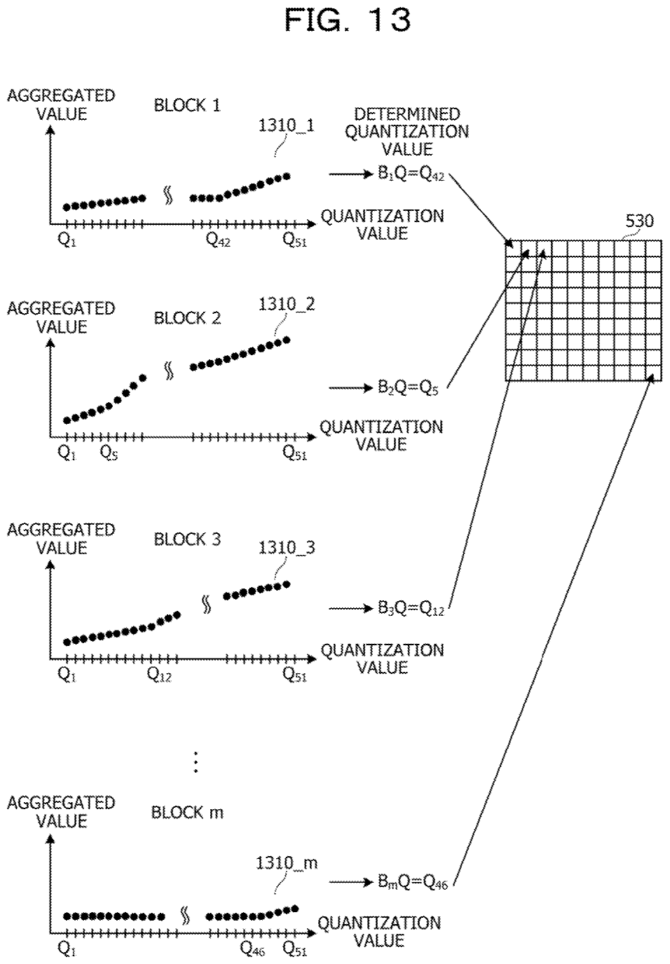

Next, a specific example of processing by the quantization value determination unit 1130 will be described. FIG. 13 is a diagram illustrating a specific example of the processing by the quantization value determination unit. In FIG. 13, graphs 1310_1 to 1310_m are graphs generated by plotting the aggregated values of each of blocks (block 1 to block m) with the quantization value on a horizontal axis and the aggregated value on a vertical axis with respect to a change in the quantization value.

The quantization value determination unit 1130 determines, for example, the quantization value of a case where the amount of change in the aggregated value exceeds a predetermined threshold in each of graphs 1310_1 to 1310_m as the determined quantization value that is the quantization value according to the optimum compression level.

The example of FIG. 13 illustrates a state in which the determined quantization value for block 1 is determined as “Q₄₂”, the determined quantization value for block 2 is determined as “Q₅”, the determined quantization value for block 3 is determined as “Q₁₂”, and the determined quantization value for block 51 is determined “Q₄₆”.

### Flow of Compression Processing by Compression Processing System

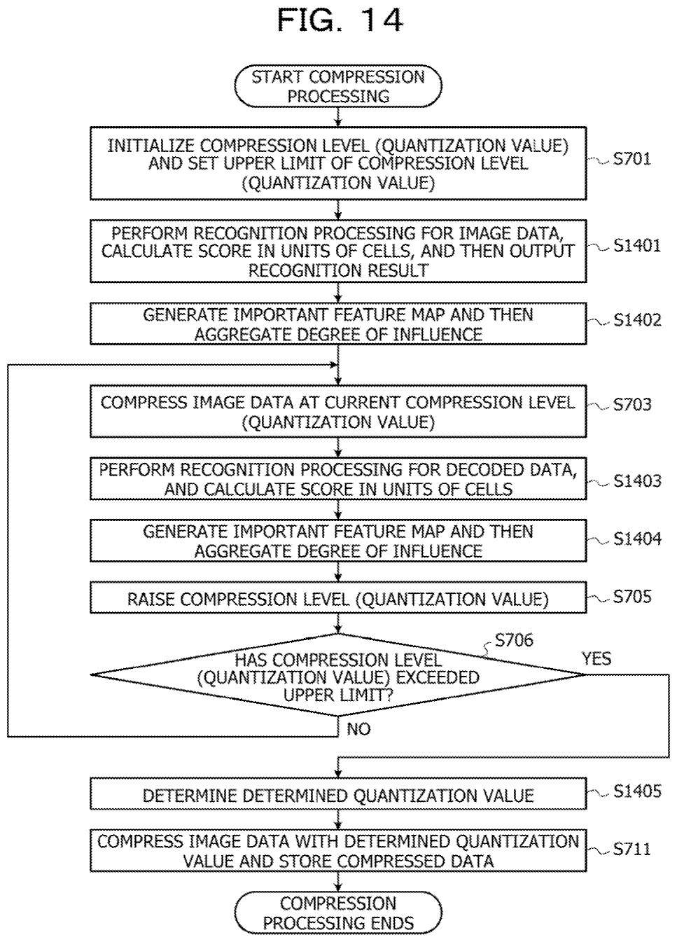

Next, a flow of the compression processing by a compression processing system 100 will be described. FIG. 14 is a third flowchart illustrating an example of the flow of the compression processing by the compression processing system. Differences from the first flowchart described with reference to FIG. 7 are steps S1401, S1402, S1403, S1404, and S1405.

In step S1401, the input unit 310 acquires image data in units of frames, and the CNN unit 1110 performs the recognition processing for the image data, calculates the score in units of cells, and then outputs the recognition result. Furthermore, the CNN unit 1110 stores the information indicating the position of the object included in the image data.

In step S1402, the important feature map generation unit 350 generates the important feature map by back-propagating the error of the score of each cell calculated for each object. Furthermore, the aggregation unit 360 aggregates the degree of influence of each area in units of blocks and stores the aggregation result in the aggregation result storage unit 390.

In step S1403, the input unit 310 acquires the compressed data and decodes the acquired compressed data to generate the decoded data. Furthermore, the CNN unit 1110 performs the recognition processing for the decoded data and outputs the score in units of cells

In step S1404, the important feature map generation unit 350 generates the important feature map by back-propagating the error of the score of each cell calculated for each object based on the information indicating the position of the object. Furthermore, the aggregation unit 360 aggregates the degree of influence of each area in units of blocks and stores the aggregation result in the aggregation result storage unit 390.

In step S1405, the quantization value determination unit 1130 determines the determined quantization value in units of blocks and transmits the determined quantization value to the image compression device 130.

As is clear from the above description, the analysis device according to the fourth embodiment performs the recognition processing for the image data and calculates the score of each cell. Furthermore, the analysis device according to the fourth embodiment specifies the position of the object included in the image data based on the calculated score of each cell. Furthermore, the analysis device according to the fourth embodiment acquires each compressed data of a case where the compression processing is performed for the image data using all the settable quantization values. Furthermore, the analysis device according to the fourth embodiment performs the recognition processing for the decoded data obtained by decoding each compressed data, and calculates the error for each object based on the information indicating the specified position of the object. Furthermore, the analysis device according to the fourth embodiment generates the important feature map indicating the degree of influence of each cell on the recognition result by back-propagating the calculated error. Furthermore, the analysis device according to the fourth embodiment aggregates the degree of influence on the recognition result in units of blocks based on the important feature map, and determines the determined quantization value of each block of the image data based on the aggregated values of each of the blocks corresponding to all the settable compression levels.

As described above, the analysis device according to the fourth embodiment uses the information indicating the position of the object, the position having been specified when performing the recognition processing for the image data, when calculating the error for each object. Thereby, it is possible to simplify the processing in the CNN unit when generating the important feature map by back-propagating the error.

As a result, according to the fourth embodiment, it is possible to implement the compression processing suitable for the image recognition processing by AI while suppressing the amount of calculation.

### Other Embodiments

In the above-described fourth embodiment, the case of simplifying the processing in the CNN unit has been described. However, similarly to the above-described first to third embodiments, the processing in the CNN unit may be further simplified while simplifying the processing up to deciding the compression level suitable for the recognition processing (alternatively, the processing up to deciding availability of a high compression level).

Furthermore, in the above-described fourth embodiment, as the model of the CNN unit, the YOLO model in which cluster processing is performed using a method such as non-maximum suppression (NMS) to obtain the recognition result (bounding box) has been described. However, a CNN model other than the YOLO model may be used as the model of the CNN unit.

Note that the present embodiment is not limited to the configurations described here and may include, for example, combinations of the configurations or the like described in the above embodiments and other elements. These points may be changed without departing from the spirit of the embodiments and may be appropriately assigned according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An analysis device comprising:
a memory; and
a processor coupled to the memory and configured to:
decide a first compression level based on a degree of influence of each area on a recognition result of a case where recognition processing is performed for each image data after a change in image quality;
in a case where image data compressed at a second compression level according to the first compression level is decoded, perform the recognition processing for decoded data and calculate a recognition result; and
determine at which compression level of the first compression level or the second compression level image data is compressed according to the calculated recognition result.

2. The analysis device according to claim 1, wherein the processor is configured to:
aggregate the degree of influence of each area on the recognition result of a case where image data is compressed at a predetermined number of different compression levels and the recognition processing is performed for each decoded data obtained by decoding each compressed data; and
decide the first compression level from the predetermined number of different compression levels based on the aggregated degree of influence of each area on the recognition result.

3. The analysis device of claim 2, wherein the second compression level is a compression level between the predetermined number of different compression levels and is a compression level higher than the first compression level.

4. The analysis device according to claim 3, wherein the processor
determines to compress the image data at the second compression level in a case where the calculated recognition result is equal to or greater than an allowable value, and
determines to compress the image data at the first compression level in a case where the calculated recognition result is less than the allowable value.

5. The analysis device according to claim 4, wherein the processor adjusts the determined compression level based on the aggregated degree of influence of each area on the recognition result.

6. The analysis device according to claim 1, wherein the processor is configured to:
aggregate the degree of influence of each area on the recognition result of a case where image data is compressed at predetermined one type of compression level, compressed data is decoded, and then the recognition processing is performed for decoded data;
decide which group the aggregated degree of influence of each area on the recognition result belongs to; and
decide a compression level associated in advance with the decided group as the first compression level.

7. The analysis device according to claim 6, wherein the second compression level is a compression level at which the aggregated degree of influence of each area on the recognition result is a predetermined degree of influence, and is a compression level associated in advance with the decided group and different from the first compression level.

8. The analysis device according to claim 7, wherein the processor determines to compress the image data at the second compression level in a case where the calculated recognition result is equal to or greater than an allowable value, and determines to compress the image data at the first compression level in a case where the calculated recognition result is less than the allowable value.

9. The analysis device according to claim 8, wherein the processor adjusts the determined compression level based on the aggregated degree of influence of each area on the recognition result.

10. An analysis device comprising:
a memory; and
a processor coupled to the memory and configured to:
perform recognition processing for image data, and aggregate output of a convolutional neural network (CNN) to calculate a score;
specify a position of an object included in the image data based on the calculated score of the output of the CNN;
calculate a degree of influence on the output of the CNN by obtaining the score of the output of the CNN by performing the recognition processing for each image data after a change in which image quality of the image data has been changed, and back-propagating an error calculated based on a position of each area of the output of the CNN and the specified position of the object; and
determine a compression level based on the degree of influence of the output of the CNN on each area.

11. An analysis device comprising:
a memory; and
a processor coupled to the memory and configured to:
perform recognition processing for image data and calculate a score of each cell;
specify a position of an object included in the image data based on the calculated score of the each cell;
calculate a degree of influence of the each cell on a recognition result by calculating the score of the each cell by performing the recognition processing for each image data after a change in which image quality of the image data has been changed, and back-propagating an error calculated based on the specified position of the object; and
determine a compression level based on the degree of influence of the each cell on the recognition result.
